(19) United States
(12) Patent Application Publication
(10) Pub. No.: US 2002/0172259 A1
(43) Pub. Date: Nov. 21, 2002

(54) Electrical temperature measuring device

(76) Inventor: Marcus Bach, Hendungen (DE)

Correspondence Address: CROWELL & MORING, L.L.P., P.O. Box 14300, Washington, DC, 20044-4300, US

(21) Appl. No.: 10/085,122

(22) Filed: Mar. 1, 2002

(30) Foreign Application Priority Data
Mar. 1, 2001 (DE) 101 09 828.6

(51) Int. Cl. G01K 1/14; G01K 13/00; G01K 7/04; G01K 7/16

(52) U.S. Cl. 374/208; 374/141; 374/179; 374/185

(57) ABSTRACT

An electrical temperature measuring device with a temperature sensor that is arranged inside a protective tube. A plug-in connector, which is capable of withstanding high temperatures without significant changes in its insulation and contact properties, is arranged at the one end of said protective tube.

### BACKGROUND AND SUMMARY OF THE INVENTON

This application claims the priority of German Application No. 101 09 828.6, filed Mar. 1, 2001, the disclosure of which is expressly incorporated by reference herein.

The invention relates to an electrical temperature measuring device with a temperature sensor that is arranged inside a protective tube. This protective tube is closed at one and at the other, open end is provided with a connection device connected to the electric lines extending inside the protective tube, by means of which the lines are detachably coupled with external electric lines.

Thermoelectric temperature measuring devices of the above-described type are known in the art. A thermocouple or an electrical resistor, respectively, which change as a function of temperature is included inside a metallic protective tube. The thermocouple and electrical resistor are used as contact sensors. The measured temperature values are remotely transmitted via the external lines.

A measuring element with a measuring resistor of a defined sensor length can be arranged inside the protective tube or the protective sheath. The measuring resistor in the interior of an insert tube is connected via internal lines to a connection point, which is provided with fastening screws or anchoring clips carried by a mounting flange connected to the end of the insert tube. The terminals with the mounting flange are located inside a housing in the form of a connection head. The insert tube juts into the protective sheath, which is provided with a threaded mounting fitting to connect the temperature measuring device with a support. This support typically consists of the wall of a container into which the protective sheathe projects and in the interior of which the temperature is to be measured. The connection head is spaced at a distance from the threaded mounting fitting to avoid exposing the electrical insulation of the terminals to high temperatures that may be present at the point where the device is screwed in. (“Elektrische Messgeräte und Messverfahren” [Electrical Measuring Devices and Measuring Methods,” 4th Edition, G. Jentsch, Springer-Verlag, Berlin Heidelberg New York 1978, pp. 368-370).

The object of the invention is to provide an electrical temperature measuring device with a temperature sensor arranged inside a protective tube, which can be quickly and easily connected to an external line with high-temperature resistant connection device and which permits correct transmission of the measured temperature values even in a mobile device that is in motion.

According to the invention, this object is attained in an electrical temperature measuring device of the initially described type by fixing a metal screw in front of the open end of the protective tube. This metal screw protrudes beyond the open end of the protective tube in the axial direction and surrounds a hollow cylindrical space that is open at one end and forms the holder of one half of a plug-in connector, which is provided with connector contacts and spring contacts coated with a precious metal or a precious metal alloy. These contacts are made of an electrically conductive metal that is creep-resistant and deformation-resistant in the specified measuring range of the temperature sensor. The connector contacts connected to the ends of the lines extending inside the protective tubes are held in the one half of the plug-in connector in a housing made of a glass fiber-filled liquid crystal polymer. The spring contacts connected to the external lines are held in the other half of the plug-in connector in a housing that is made of the same material as the housing in which the connector contacts are held.

With the metal screw, which simultaneously forms the holder of a plug-in connector half, the inventive temperature measuring device can be screwed into an interior thread in the wall of a container or a housing, the interior temperature of which is to be measured. The space required outside the container of the temperature measuring device is therefore small, since the neck length outside the respective container, required in the known contact temperature measuring devices with protective tubes, is eliminated. The inventive temperature measuring device furthermore weighs less due to this elimination of the neck length. The temperature measuring device is not sensitive to shocks, i.e., the transmission of the measured temperature values is not significantly affected during motion. It has been shown that glass fiber-filled liquid crystal polymers are particularly well suited as an insulation material for electrical conductors in a temperature range of up to a few hundred degrees Celsius.

Preferably, the connector contacts and the spring contacts each have a nickel-beryllium alloy as the contact carrier material. It has been shown that this material has good mechanical strength and good elastic properties as well as high corrosion resistance with adequate electrical conductivity in a temperature measuring range from −40° C. to a few hundred ° C. In particular, the heat-treatable nickel-beryllium alloy has a beryllium content of less than 2, particularly 1.85 percent by weight. In an advantageous embodiment, the metal screw and the protective tube are joined by hard soldering so as to be pressure-tight.

In a further preferred embodiment, on a wall area of the housing of the one connector half that protrudes over the metal screw in axial direction of the screw, a locking projection is provided to engage with a recess, which is provided in a wall of the housing of the other connector half. With this locking connection, the connector halves can be quickly and easily connected by hand.

Preferably, electrical lines, which are respectively provided with an insulating sheath of aromatic polyimides and an outer sheath of polytetrafluoroethylene, are connected to the spring contacts of the one connector half. This insulation is well suited for high temperatures. The temperature sensor is preferably a thermocouple or a metallic conductor.

It is furthermore advantageous if a metal seal or a fluoroelastomer seal is arranged between the end face of the metal screw and the bottom of a metal nut, which is provided with a passage for the protective tube and is arranged in a container wall.

A temperature measuring device of the aforementioned type is used, in particular, to measure the temperature in the interior of a thermally insulated gas generator box with components for generating hydrogen from methanol to supply a fuel cell.

Other objects, advantages and novel features of the present invention will become apparent from the following detailed description of the invention when considered in conjunction with the accompanying drawings.

### BRIEF DESCRIPTION OF THE DRAWINGS

The invention and its features, details and advantages will now be described in greater detail with reference to an exemplary embodiment depicted in the drawing in which

FIG. 1 is a longitudinal section through an electrical temperature measuring device with a plug-in connector whose connector halves are spaced at a distance from one another,

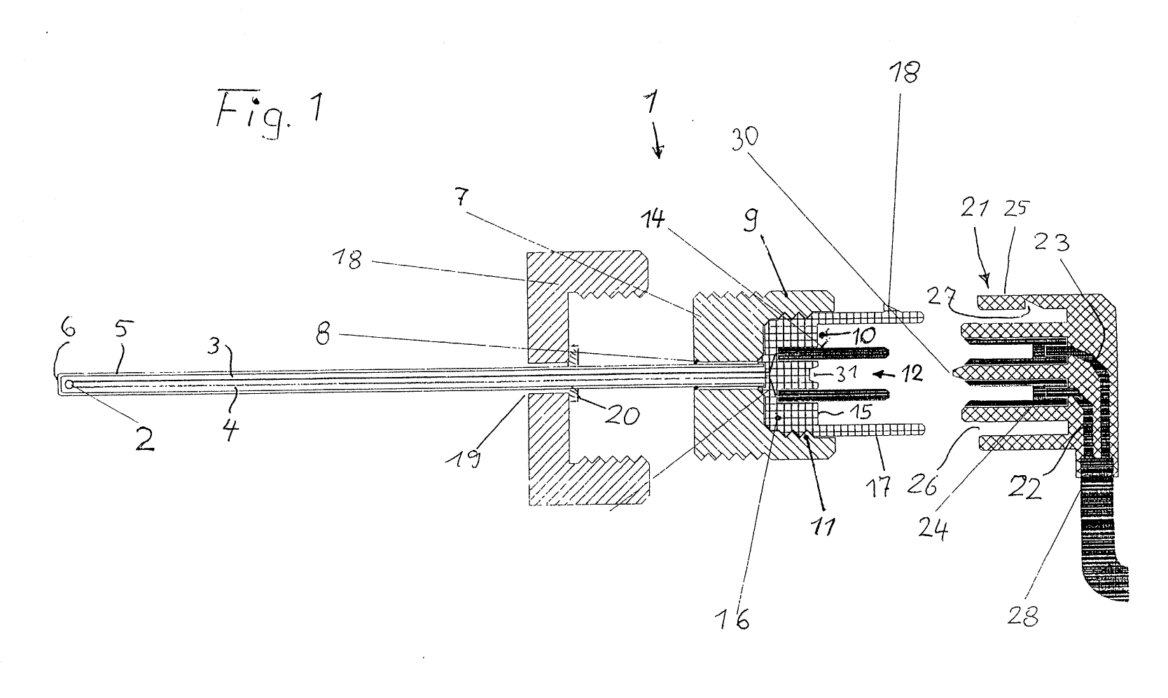

FIG. 2 is a longitudinal section through the temperature measuring device shown in FIG. 1 in the assembled state.

### DETAILED DESCRIPTION OF THE PREFERRED EMBODIMENTS

The electrical temperature measuring device 1 embodies a temperature sensor 2, particularly a thermocouple of two wires 3, 4 made of different materials, which are soldered or welded together at their ends. Instead of a thermocouple, a metallic conductor whose resistance changes with temperature can be provided. The thermocouple 2, i.e., the point at which the two wires 3, 4 are joined together, and the two wires 3, 4 are located inside a protective tube 5 or a protective sheathe made of metal. This protective tube 5 is closed at one, end 6. The thermocouple 2 is located inside the protective tube 5 near the end 6. At the other end, the protective tube 5 is open.

A metal screw 7 surrounds the protective tube 5 in the zone adjacent to the open end of the protective tube 5. The metal screw 7 has a central, axially extending through-hole (not shown in detail) into which is inserted the end of the protective tube 5, which is joined to the metal screw by hard solder 8. The hard solder 8 is located at least in the gap between the lateral surface of protective tube 5 and the inner wall of the bore of the metal screw 7 or in an area of the gap whose length is sufficient for a solid and tight connection between metal screw 7 and protective tube 5.

Metal screw 7 has a wall segment 9 that axially protrudes over the open end of the protective tube 5 and encloses a hollow cylindrical space 10 with projections 11 along the inner walls. Space 10, which is open at the end facing away from protective tube 5, has a larger cross section than the bore of metal screw 7 that is intended to receive the protective tube segment adjacent to the protective tube end.

Space 10 holds one half 12 of a plug-in connector 13. This connector half 12 has connector contacts 14 or blade contacts, which are coated with a precious metal or a precious metal alloy and are connected, respectively, with one of the ends of wires 3, 4. The ends (not shown in detail) of wires 3, 4 are brought out of the protective tube 5 and are welded or hard soldered to the connector contacts 14. The connector contacts 14 are made of a migration-free, electrically conductive material or metal that is creep-resistant and deformation-resistant in the measuring range of the temperature measuring device 1. In a preferred measuring range of the temperature measuring device of up to 300° C., the material of the contact pins 14, i.e., the contact carrier material, is made of a heat-treatable, ferromagnetic nickel alloy, which has good shaping properties, so that the connector contacts 14 can be machined into crimp contacts on conventional stamping machines. In particular, this material is an alloy with 1.85 wt-% beryllium, with the balance being nickel. A nickel-beryllium alloy with the following composition and the following properties is preferred:

| | |
|---|---|
| Melting temperature: | 1160° C. |
| Linear thermal expansion coefficient: | 13.8 * 10⁻⁶ K⁻¹ |
| Thermal capacity: | 30 Wm−1 K−1 |
| Tensile strength: in the untreated state: | 980 MPa |
| in the treated state: | 1830 MPa |
| Elongation at break: | 5% |
| Modulus of elasticity: | 200 GPa |
| Torsion modulus: | 85 GPa |
| Bending yield limit in the treated state: | 1.2 GPa |
| Fatigue strength under reversed bending stress: | 560 MPa |
| Vickers hardness: in the untreated state: | 330 HV |
| in the treated state: | 570 HV |
| Specific electrical conductivity: in the untreated state: | 3 MS/m |
| in the treated state: | 4 MS/m |
| Density: | 8.25 g/cm³ |
| Aftertreatment: | 2 h at 500° C. |

A nickel-beryllium alloy with the above properties is commercially available from Vacuumschmelze, Hanau, under the brand name Beryvac 520.

The above alloy becomes very hard after heat-treatment and has excellent fatigue strength under reversed bending stress. It can withstand prolonged exposure to high temperatures of e.g., 300° C., has increased thermal and electrical conductivity, and is corrosion-resistant.

The connector contacts 14 are preferably coated with silver. Oxide particle-reinforced silver is also suitable as a coating material. Silver does not corrode at room temperature in either humid or dry air. The presence of sulfur, however, produces silver sulfide coatings. At temperatures of 200° C. and above, these silver sulfide coatings will dissolve or disappear. Any sulfide coatings that may possibly be present are broken through when the connector is plugged in. A silver-palladium coating is also suitable. For especially high temperatures, silver-rhenium contacts may be used. Their contact resistance does not significantly increase even at 900° C.

The connector contacts 14 are arranged inside a housing 15 made of an electrically insulating material. Housing 15 with its base 16 is embedded in hollow space 10 and with base 16 fills out the spaces between projections 11 to obtain a secure seat inside metal screw 7 which is fixed advantageously by forming a helical outer wall and a wall with an internal thread of the nut. From base 16, along the edge of the end facing away from protective tube 5, a cylindrical section 17 protrudes beyond metal screw 7 and surrounds, at a radial distance, the connector segments protruding from base 16. A locking projection 18 is arranged on the cylindrical outer wall of section 17.

Housing 15 is made of an electrical insulating material composed of a glass fiber-filled liquid crystal polymer. Above the melting point, the liquid crystal polymer, in its liquid state, already forms ordered structures. This behavior is referred to as thermotropic. The liquid crystal polymers used are those with mesomorphic phases, primarily of a nematic nature. These materials have excellent electrical insulation properties and mechanical properties, which result from fibrous, self-reinforcing structures that are very similar to wood. The mechanical characteristics can be significantly improved by glass or carbon fibers.

For a temperature measuring device 1 whose temperature sensor 2 is arranged in protective tube 5 in the interior of a container, housing, tube, or reactor (not depicted) where the interior temperature does not exceed approximately 300° C., a suitable insulating material for the plug-in connector 15 in the metal screw 9, which is arranged directly on the outside of the container, housing, or reactor, is a glass fiber-filled liquid crystal polymer composite with the following properties:

| | |
|---|---|
| Maximum continuous temperature (600 h) in accordance with | |
| DIN/ISO: | 240° C. |
| Maximum temperature in accordance with DIN/ISO: | 303° C. |
| Thermostability temperature in accordance with ISO 75: | 303° C. |
| Melting temperature in accordance with DIN 53736: | 357° C. |
| Glass transition temperature in accordance with DIN 53736: | 120° C. |
| Oxygen index in accordance with ISO 4589: | 38.5% |
| Linear thermal expansion coefficient in accordance with ASTM: | E 228 (23° C.) |
| in flow direction: | 1.4 * 10⁻⁵ K⁻² |
| perpendicular to flow direction: | 3.6 * 10⁻⁵ K⁻¹ |
| Thermal conductivity: | 0.32 Wm⁻¹ K⁻¹ |
| Tensile strength in accordance with ASTM D 638 (23° C.): | 119 MPa |
| Tensile strength in accordance with ASTM D 638 (149° C.): | 40 MPa |
| Elongation at break: | 1.1% |
| Tension modulus in accordance with D 638 (23° C.): | 18.6 GPa |
| Tension modulus in accordance with D 638 (149° C.): | 9.0 GPa |
| Bending fatigue strength in accordance with ASTM, D 790 | |
| (23° C.): | 158 MPA |
| Bending fatigue strength in accordance with ASTM, D 790 (149° C.): | 24 MPa |
| Bending modulus of elasticity in accordance with ASTM, D 790 | |
| (23° C.): | 13.8 GPa |
| Bending modulus of elasticity in accordance with ASTM, D 790 | |
| (250° C.): | 6.6 GPa |
| Rockwell Hardness R in accordance with ASTM, D 785: | 110 |
| Rockwell Hardness M in accordance with ASTM, D 785: | 63 |
| Volume resistivity in accordance with ASTM, D 257: | 1 * 10¹⁶Ωcm |
| Surface resistance in accordance with ASTM, D 257: | 1 * 10¹⁵Ωcm |
| Dielectric constant in accordance with ASTM, D 150, 1 KHz: | 4.6 |
| Loss factor in accordance with ASTM, D 150, 1 KHz: | 0.013 |
| Tracking resistance CII-Index, ASTM, UL 746 A: | 192 V |
| Density in accordance with ASTM, D 792: | 1.81 g/cm³ |

A composite of a liquid crystal polymer with a glass fiber content of up to 45 wt-% is commercially available from DuPont Deutschland GmbH under the name Zenite LCP 7145L WT010.

It has been shown that the above-described liquid crystal polymer composite with up to 45 wt-% glass fibers is excellently suited for the plug-in connector 15. Also favorable is its thermoplastic processability, which permits injection molding as well as extrusion. The liquid crystal structure in the melt and the very low fusion heat permit very short injection molding cycle times, which are 30-50% lower than for conventional plastics.

The excellent flow properties permit thin-walled profiles and bur-free fabrication with injection molding. The material exhibits high notch-impact strength and high resistance against corrosion by chemicals as well as low water absorption. It also has high thermal stability, which permits the high application temperatures.

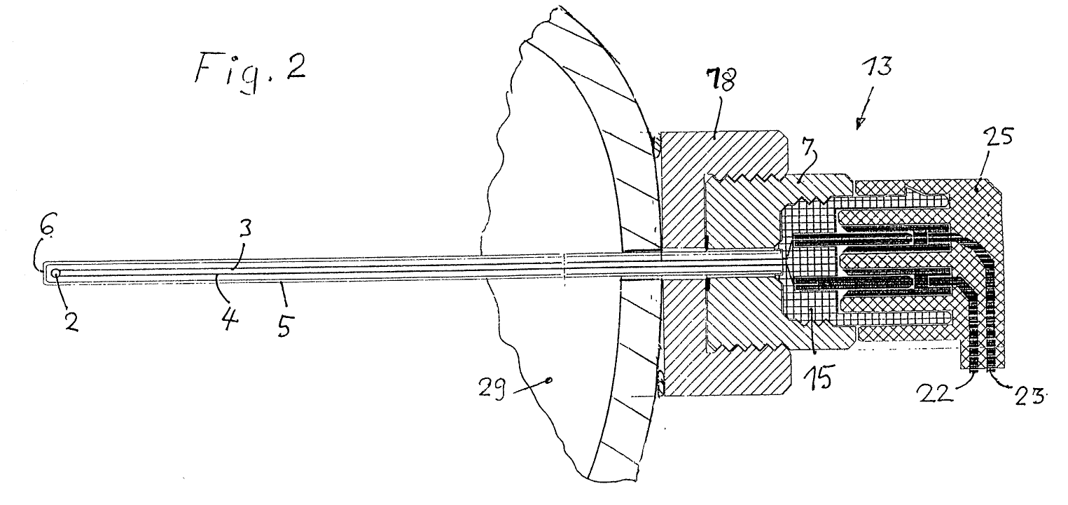

Suitable liquid crystal polymers are polyterephthalates, polyarylates and polyesters. To fasten the metal screw to the wall of the container, housing, reactor or tube, a metal nut 18 is provided, which is welded to the container, housing, or reactor. In order to seal bore 19 in metal screw 18 through which the protective tube 5 extends, a standard seal 20 made of metal or a fluoroelastomer is provided. FIG. 2 depicts a part of a container 29 in cross section.

The second connector half 21 comprises spring contacts 24 connected, respectively, to external lines 22, 23. These spring contacts are made of the same material as the connector contacts 14 and also have the same coating materials as the electrical contacts. The spring contacts 24 connected to the ends of the external lines 22, 23 are located in a housing 25 made of the same composite material as housing 15. The spring contacts 24 are surrounded by the insulating material of housing 15, except for the receiving spaces for the connector contacts 14.

Spaced apart from the spring contacts 24, in a radially outward direction inside housing 15, an open cylindrical hollow space 26 is provided on the connector end-face side. When the connector halves 12, 21 are joined, section 17 is inserted into this hollow space 26. Projection 18 snaps into a recess 27 provided on the outside of hollow space 26.

If electrical resistors are used as the temperature sensors, external lines 22, 23 are nickel-plated copper lines with a 0.5 mm² cross-section and are provided, respectively, with a polyimide insulation. Polyimides are distinguished by their high strength over a broad temperature range. A particularly suitable polyimide is available from DuPont Deutschland GmbH under the trade name Kapton.

For protection, the polyimide insulation is provided with a sheath 28 made of polytetrafluoroethylene. A particularly suitable polytetrafluoroethylene is commercially available from DuPont Deutschland GmbH under the trade name Teflon.

The temperature sensors used, in particular, are thermocouples and electrical resistors. The thermocouples can be K-type (NiCr/Ni) thermocouples. In thermocouples with ceramic sheathing at the welding point, the two lines, a nickel line and a nickel-chromium line, are disposed in an insulation filler inside protective tube 5.

Electrical resistance temperature sensors are e.g., PT 1000 type sensors.

In a thermocouple temperature sensor, lines 22, 23 are made of the same material as the thermocouple lines for a measuring range greater than 200° C. For a measuring range below 200° C., lines 22, 23 are embodied as equalizing lines. The individual wires advantageously have a cross-section of at least 0.5 mm². The insulation of lines 22, 23 in a thermocouple sensor is the same as that described in connection with nickel-plated copper lines. Between the spring contacts 24, a projection 30 protrudes beyond the contact ends. This projection 30 engages with a recess 31 of housing 15 when the connector halves are joined and is intended to provide reverse voltage protection and to increase the creepage distance.

The temperature measuring device according to the invention makes it possible to mount the connection elements to external units directly on the corresponding container or housing into which the protective tube with the temperature sensor projects.

The small space requirement is advantageous in mobile devices, e.g., vehicles with fuel cells as energy suppliers. Furthermore, the connections to the external units can be readily coupled and uncoupled by hand.

Thus, the temperature measuring devices according to the invention are particularly suitable to determine the temperatures in the interior of a thermally insulated gas generation box with components for generating hydrogen from methanol. The hydrogen is supplied to a fuel cell, the energy source in a mobile apparatus, particularly a motor vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. An electrical temperature measuring device comprising:
a temperature sensor arranged in a protective tube, which is closed at one end and opened at another end;
connection means provided at said open end for connection to electrical lines extending inside the protective tube, wherein said connection means provide that said lines are detachably coupled to external electrical lines;
a metal screw is fixed to the protective tube in front of said open end and axially protruding over the open end of the protective tube wherein said metal screw surrounds a hollow cylindrical space, which is open at one end and forms the holder for one half of a plug-in connector provided with connector contacts and spring contacts, which are each coated with a precious metal or a precious metal alloy and are made of an electrically conductive metal that is creep-resistant and deformation-resistant in the specified measuring range of the temperature sensor, wherein the connector contacts are connected to the ends of lines extending inside the protective tube and said lines are held in said one half of the plug-in connector inside a first housing made of a glass fiber-filled liquid crystal polymer, and the spring contacts are connected to external lines and are held in another half of the plug-in connector inside a second housing, which is made of the same material as said first housing in which the connector contacts are arranged.

2. The temperature measuring device as claimed in claim 1, wherein the connector contacts and spring contacts each have a nickel-beryllium alloy as a contact carrier material.

3. The temperature measuring device as claimed in claim 1, wherein the metal screw is hard soldered to the protective tube in a pressure-tight manner.

4. The temperature measuring device as claimed in claim 1, wherein a locking projection is provided on a wall zone of said first housing of the one connector half that is provided with the connector contacts, which wall zone is axially protruding over metal screw, for engagement with a recess that is provided in a wall of second housing of the other connector half.

5. The temperature measuring device as claimed in claim 1, wherein electrical lines are each provided with an aromatic polyimide insulating sheath and an outer polytetrafluoroethylene sheathe, and said electrical lines are connected to the spring contacts of the one connector half.

6. The temperature measuring device as claimed in claim 1, wherein a metal or fluoroelastomer seal is arranged between the end face of the metal screw and a bottom of a metal nut, which metal nut is provided with a passage for the protective tube and is arranged in a container or housing wall to receive the metal screw.

7. The temperature measuring device as claimed in claim 1, wherein a thermocouple is provided as the temperature sensor.

8. The temperature measuring device as claimed in claim 1, wherein an electrical resistor temperature sensor is arranged in the protective tube and the external lines are each made of nickel-plated copper.

9. The temperature measuring device as claimed in claim 7, wherein the external lines are made of the same material as the lines of the thermocouple for a measuring range greater than 200° C., and for a smaller measuring range the external lines consist of equalizing lines.

10. The temperature measuring device as claimed in claim 1, wherein the liquid crystal polymer is a polyester.

11. The temperature measuring device as claimed in claim 1, wherein the liquid crystal polymer is a polyterephthalate.

12. The temperature measuring device as claimed in claim 1, wherin the liquid crystal polymer is a polyarylate.

13. The temperature measuring device as claimed in claim 1, wherein the temperature being measured is the temperature in the interior of a thermally insulated gas generation box with components for generating hydrogen from methanol to supply a fuel cell.

14. The temperature measuring device as claimed in claim 2, wherein the metal screw is hard soldered to the protective tube in a pressure-tight manner.

15. The temperature measuring device as claimed in claim 2, wherein a locking projection is provided on a wall zone of said first housing of the one connector half that is provided with the connector contacts, which wall zone is axially protruding over metal screw, for engagement with a recess that is provided in a wall of second housing of the other connector half.

16. The temperature measuring device as claimed in claim 3, wherein a locking projection is provided on a wall zone of said first housing of the one connector half that is provided with the connector contacts, which wall zone is axially protruding over metal screw, for engagement with a recess that is provided in a wall of second housing of the other connector half.

17. The temperature measuring device as claimed in claim 2, wherein electrical lines are each provided with an aromatic polyimide insulating sheath and an outer polytetrafluoroethylene sheathe, and said electrical lines are connected to the spring contacts of the one connector half.

18. The temperature measuring device as claimed in claim 3, wherein electrical lines are each provided with an aromatic polyimide insulating sheath and an outer polytetrafluoroethylene sheathe, and said electrical lines are connected to the spring contacts of the one connector half.

19. The temperature measuring device as claimed in claim 4, wherein electrical lines are each provided with an aromatic polyimide insulating sheath and an outer polytetrafluoroethylene sheathe, and said electrical lines are connected to the spring contacts of the one connector half.

20. The temperature measuring device as claimed in claim 2, wherein a metal or fluoroelastomer seal is arranged between the end face of the metal screw and a bottom of a metal nut, which metal nut is provided with a passage for the protective tube and is arranged in a container or housing wall to receive the metal screw.
